(19) United States
(12) Patent Application Publication
(10) Pub. No.: US 2024/0190009 A1
(43) Pub. Date: Jun. 13, 2024

(54) AUTOMATED SOLAR ROBOT SYSTEM AND METHOD

(71) Applicant: ULC Technologies LLC, Hauppauge, NY (US)

(72) Inventors: Ali Asmari, Center Moriches, NY (US); Brian Lynn, Rockville Centre, NY (US); Benjamin Artes, Nesconset, NY (US); Eric Feldman, Glen Head, NY (US); Michael Hauser, East Rockaway, NY (US); Guoxuan Zhang, Hauppauge, NY (US); G. Greg Penza, Old Field, NY (US); Robert E. Kodadek, III, Long Beach, NY (US)

(21) Appl. No.: 18/534,357

(22) Filed: Dec. 8, 2023

Related U.S. Application Data
(60) Provisional application No. 63/386,626, filed on Dec. 8, 2022.

(51) Int. Cl. B25J 9/16; B25J 11/00; B25J 15/06; B25J 19/00

(52) U.S. Cl. CPC B25J 9/1687; B25J 9/162; B25J 9/1669; B25J 9/1697; B25J 11/008; B25J 15/0616; B25J 19/0075

(57) ABSTRACT

A system and method for installing solar panels using an advanced robotic system of one or more autonomous machines is provided. The system for installing solar panels can include a solar panel setting robot provided in the form of a first robotic system, a plurality of solar panel carrying robots provided in the form of a second robotic system, and a control system designed to coordinate installation activities between the solar panel setting robot and the solar panel carrying robot. The installation process may include identifying an installation location for the first solar panel installation, driving one or more of the autonomous machines to the installation location, and initiating an installation process. The initiation process may include sending a notification that the installation process has been initiated, retrieving a solar panel from the solar panel carrying robot, aligning the solar panel, and completing the solar panel installation process.

### RELATED APPLICATIONS

This application claims priority to U.S. Provisional Patent Application No. 63/386,626 filed Dec. 8, 2022, the entire disclosure of which is incorporated herein by reference.

### FIELD OF THE INVENTION

This disclosure generally relates to automated solar robots. More specifically, this disclosure relates to a system and a method for installing solar panels using automated solar robots.

### BACKGROUND OF THE INVENTION

Existing systems and methods for installing solar panels are inefficient and substantially impacted by the terrain and site layout of a solar panel farm. Additionally, conventional solar panel installation systems are time-consuming and burdensome, often involving highly skilled laborers to install solar panels onto torque tubes. Further, solar panel installation systems are not well-adapted for installation by autonomous machines. For example, conventional solar panel installation systems may require a step-by-step process where brackets are slid onto torque tubes, panels are then moved horizontally onto the brackets, and finally, a plurality of fasteners are engaged on an underside of the bracket.

Additional obstacles for maximizing the installation rate of solar panels include cable conduits or snake trays that split the rows of torque tubes and prevent the passage of autonomous machines from one end to another in a continuous path. Another obstacle is narrow pathways. To maximize the use of land on a solar panel farm, the fields are arranged such that, in most cases, two automated robots would not be able to pass by each other without colliding with the solar farm infrastructure, or with each other.

Thus, there is a need to streamline the installation process of solar panels and facilitate the user of autonomous robots to complete the installation process.

### BRIEF SUMMARY OF THE INVENTION

An aspect of this disclosure pertains to a method and system for installing solar panels using autonomous robots, which can improve solar panel installation times and decrease installation costs.

An advanced robotic system for installing solar panels is provided. The system may include a solar panel setting robot provided in the form of a first robotic system including a robotic arm assembly designed to articulate a solar panel and install the solar panel on a bracket coupled to a torque tube. The system also includes an end effector rotatably coupled to an end of the robotic arm assembly. The system also includes multiple vacuum pods attached to a frame of the end effector. The vacuum pods are designed to suction to the solar panel. A solar panel carrying robot provided in the form of a second robotic system is also included in the system. The solar panel carrying robot is designed to carry multiple solar panels and travel in proximity to the solar panel setting robot. The system also includes a control panel configured to coordinate installation activities between the solar panel setting robot and the solar panel carrying robot.

In some aspects, the control system includes a panel delivery control system, a panel placement control system, and a central controller. In some embodiments, the central controller includes a vision module, a notification module, a sensor module, a communication module, and an electrical safety system. In some embodiments, the solar panel setting robot is configured to identify an installation location for a solar panel and deploy a notification through the notification module of the control system. In some embodiments, the control system includes a disconnect switch. In some embodiments, the solar panel setting robot uses a vision module to align the solar panel with the bracket. In some embodiments, the system also includes multiple solar panel carrier robots designed to communicate with each other to facilitate continuous solar panel installation. In some embodiments, the communication module sends a release signal to the system to indicate that the panel setting robot is no longer moving or is otherwise aligned in an installation position. The panel placement control system also includes a fastening control system for tightening one or more fasteners to secure the solar panel to the bracket. In some forms, the electrical safety system is configured to integrate dynamic robotic zoning zones defining a three-dimensional work zone for the first robotic system and the second robotic system.

In another aspect, an advanced robotic system for installing solar panels is provided. The system may include a solar panel setting robot provided in the form of a first robotic system. The solar panel setting robot may include a waterproof housing, a robotic drive assembly designed to transport the solar panel setting robot from one location to another, a local controller, a robotic arm assembly designed to articulate a robotic arm of the solar panel setting robot, and an end effector designed to removably couple to a solar panel. The system may also include a plurality of solar panel carrying robots provided in the form of a second robotic system including one or more modules. The system also includes a control system designed to coordinate installation activities between the solar panel setting robot and the solar panel carrying robot.

In some embodiments, the control system further includes a panel delivery control system with an advanced navigation system for planning a route from a solar panel pickup location to a solar panel installation location. The system can also include a panel placement control system comprising a vision module for aligning the solar panel with a bracket. The system can also include a central controller designed to control one or more aspects of the first robotic system, the second robotic system, or a combination thereof. In some forms, the central controller also includes a notification module, a sensor module provided in the form of a sensor array, a communication module, and an electrical safety system. In some aspects, the end effector may include a frame configured to couple with the robotic arm assembly, a vacuum pump, and a plurality of vacuum pods, each configured to selectively engage with a plurality of solar panels. In some embodiments, the end effector may include a plurality of nozzles configured to remove debris from a front surface of a solar panel. In some forms, the frame may include a chassis portion, a spacing member, a first alignment arm, a second alignment arm, and a third alignment arm. In some embodiments, vacuum pump is configured to de-energize to release the solar panel from the vacuum pods after the solar panel is installed.

A method for installing solar panels using an advanced robotic platform is provided. The method can include providing one or more autonomous machines provided in a form of a solar panel setting robot. The method further includes identifying an installation location for the first solar panel installation using a navigation module of the solar panel setting robot. The method also includes driving the one or more autonomous machines to the installation location using a drive module of the solar panel setting robot. The method further includes initiating an installation process, which includes sending a notification to a central controller using a communication module that the installation process has been initiated. The method includes retrieving a solar panel from the solar panel carrying robot using a robotic arm of the panel setting robot. The method also includes aligning the solar panel according to one or more parameters using a vision module. The method further includes fastening the solar panel to the bracket using one or more fasteners.

In some embodiments, the process of aligning the solar panel also includes applying a suction pressure to a plurality of vacuum pods to couple the solar panel to an end effector coupled to an end of the robotic arm assembly of the solar panel setting robot. The method also includes moving the end effector from a first position to a second position where the solar panel is positioned on the plurality of brackets on a torque tube at the second position. The method further includes de-energizing the vacuum pumps and disengaging the end effector from the solar panel such that the end effector may move independently of the solar panel. In some embodiments, the method also includes identifying the solar panel as being installed using the vision module. The identification process includes identifying a unique identifier of the solar panel. In some forms, the method also includes transmitting an installation notification to a data store including the unique identifier associated with the solar panel and an installed status.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 illustrates a partial isometric view of a solar panel installation system;

FIG. 2 illustrates a partial top isometric view of an end effector for the solar panel installation system of FIG. 1;

FIG. 3 illustrates another isometric view of the end effector for the solar panel installation system of FIG. 1;

FIG. 4A illustrates an isometric view of a further embodiment of an end effector for the solar panel installation system of FIG. 1 in a first position;

FIG. 4B illustrates an isometric view of the end effector of FIG. 4A in a second position;

FIG. 4C illustrates an isometric view of a the end effector of FIGS. 4A and 4B in a third position;

FIG. 5 illustrates an isometric view of an embodiment of a panel carrying robot and a panel setting robot for the solar panel installation system of FIG. 1;

FIG. 6 illustrates an isometric view of a fastening control system;

FIG. 7 is a block diagram of a control system for the solar panel installation system of FIG. 1; and

FIG. 8 is a block diagram of a method for installing a solar panel in the solar panel installation system of FIG. 1.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not for limitation.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A,

B, and/or C, and, in the case that any of A, B, and/or C indicates a category of elements, single or multiple instances of any of the elements of the categories A, B, and/or C.

Some embodiments provide a system provided in the form of multiple robotic systems for installing solar panels. Some embodiments include a method of advanced navigation techniques to determine and initiate an optimized installation strategy. In some embodiments, the robotic systems work in tandem with one another and/or operators and/or other automated systems to efficiently complete a solar panel installation process in specific locations. In some embodiments, the automated robotic system described herein can install two solar panels and travel to a location of the next panel installation in under two minutes.

The system includes a three-robot system provided in the form of two panel carrying robots and one panel setting robot. In some embodiments, other configurations are contemplated.

In some embodiments, the panel setting robot is further designed to identify an installation location for a solar panel, and deploy a notification, via a notification module, to one or more other modules of the connected system. The panel setting robot can be configured to retrieve a solar panel from the panel carrying robot and align the solar panel in the installation position. In some embodiments, the panel setting robot includes a robotic arm with multiple degrees of freedom and uses the robotic arm to retrieve the solar panels from the one or more solar panel carrying robots. In some embodiments, the solar panel can be positioned over a torque tube and held in place by the panel setting robot. In some embodiments, the panel setting robot uses a vision module to align the solar panel. In some aspects, the alignment process includes confirming an orientation of the solar panel.

In some embodiments, the robotic systems can cooperate with operators, one or more automated systems, or additional robot systems to complete the solar panel installation. In some embodiments, a sequence of one or more actions performed by the robotic platform can be controlled by a release signal (or similar) via a communication module, to indicate that the panel setting robot is no longer moving, or is otherwise aligned in the installation position, and the next phase of installation can begin. In some embodiments, a sensor module can communicate with a control module to perform the steps of solar panel alignment and installation.

In some embodiments, the process of determining a location for the solar panel installation, retrieving and aligning the panel, and completing the installation can be iteratively repeated until the solar panels are installed.

In some embodiments, the robotic system can further include one or more modules or subassemblies including, but not limited to: a control system, a notification module, a sensor module, a communication module, an electrical module, a power module, a safety system module, a vision module, and other modules and subsystems. In some forms, the power module includes a generator and a rechargeable battery management system. In some embodiments, other modules or subassemblies are contemplated.

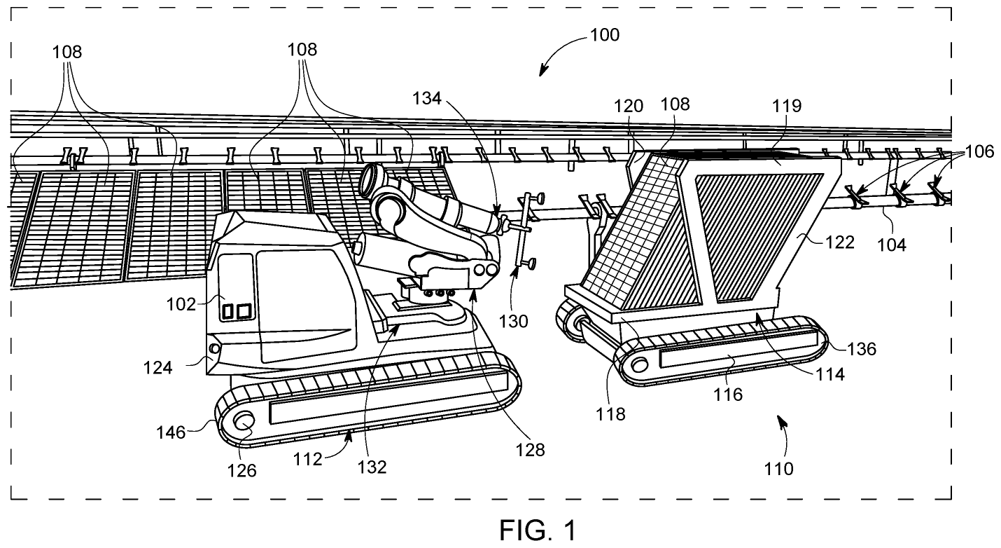

As shown in FIG. 1, a solar panel installation system 100 is provided in the form of one or more autonomous machines designed to work collaboratively to install one or more solar panels 108. The one or more autonomous machines may be provided in the form of a panel carrying robot 110 and a panel setting robot 112. The solar panel installation system 100 is designed to install solar panels 108 on brackets 106 that are coupled to torque tubes 104. The torque tubes 104 are designed to support one or more brackets 106, and the brackets 106 are designed to support one or more solar panels 108.

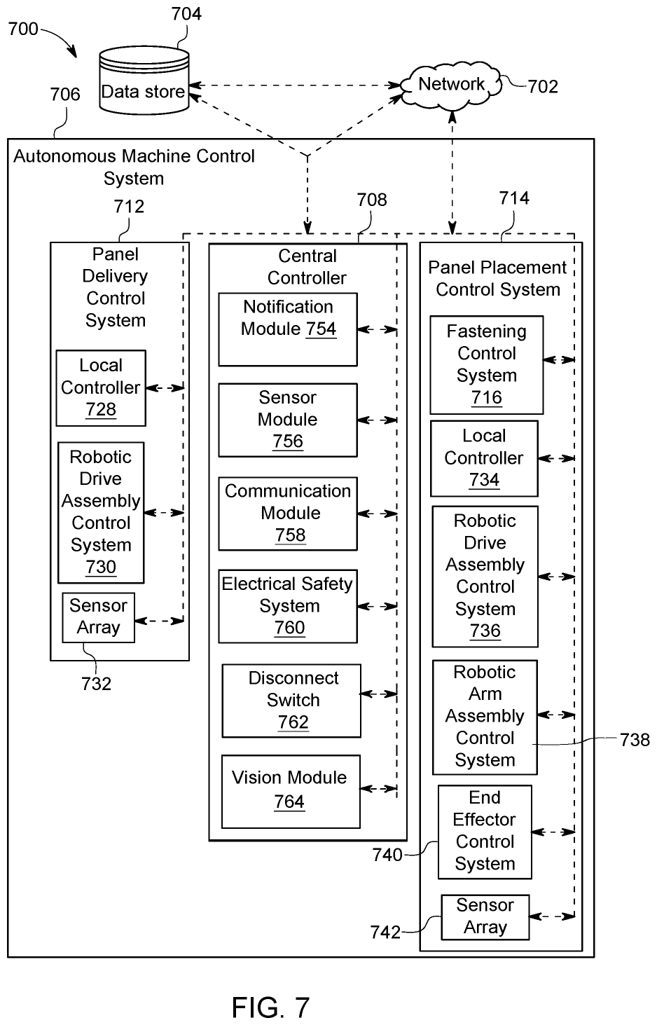

The one or more autonomous machines are designed to work collaboratively to install one or more of the solar panels 108 onto one or more of the brackets 106. In some embodiments, the panel carrying robot 110 may be referred to as a panel delivery machine, and the panel setting robot 112 may be referred to as a panel placement machine. In operation, a control system 700 (see FIG. 7) of the solar panel installation system 100 may execute instructions to the panel carrying robot 110 to transport one or more solar panels 108 to the panel setting robot 112, and the panel setting robot 112 may retrieve one or more of the solar panels 108 from the panel carrying robot 110 and place the solar panels 108 onto the brackets 106. In some embodiments, the one or more autonomous machines include more than one panel carrying robot 110 and/or more than one panel setting robot 112. In yet other embodiments, the panel carrying robot 110 and the panel setting robot 112 are a combined system provided with a common drivetrain and/or common housing. In other embodiments, multiple systems for installing solar panels 100 each containing one or more autonomous machines, may communicate and or collaborate to install solar panels 108. For example, multiple sets of panel setting robots 112 and panel carrying robots 110 may work collaboratively to install solar panels 108 on a solar farm. In some embodiments, the panel setting robot 112 can use a vision module 764 (see FIG. 7) to retrieve the solar panel(s) 108 from the panel carrying robot 110 based on a position determined through a localization process. In this example, backup measurements can be determined using sensor data from an end effector 130 of the panel setting robot 112.

The panel carrying robot 110 is designed to transport one or more solar panels 108 and may include a frame 114, a robotic drive assembly 116, and a local controller 728 (see FIG. 7). The frame 114 is designed to receive and hold one or more solar panels 108 on the panel carrying robot 110. The frame 114 may be provided in the form of a floor member 118, a first side rail 119, a second side rail 120, and a rear support member 122. The floor member 118 is substantially rectangular and designed to support the solar panels 108 on the robotic drive assembly 116. The first side rail 119 and the second side rail 120 protrude outward and away from the floor member 118 from opposing sides of the floor member 118. The side rails 119 and 120 are designed to abut the solar panels 108 to prevent the solar panels 108 from tipping out of the frame 114 or sliding off the floor member 118. For example, the side rails 119 and 120 may be provided in the form of V-shaped metal plates. Additionally, the rear support member 122 may protrude away from the floor member 118 to abut the solar panels 108. For example, the rear support member 122 may span between the first side rail 119, the second side rail 120, and the floor member 118 to further retain the solar panels 108 in the frame 114.

The robotic drive assembly 116 is designed to propel and maneuver the panel carrying robot 110 and may be provided in the form of a track component 136 positioned and located on opposing sides of the frame 114. It will be understood that the track component 136 can be provided in the form of wheels or other forms of movable support for the robotic platform. As will be described in further detail in connection with FIG. 7, the robotic drive assembly 116 may be controlled by the local controller 728 to maneuver or drive the panel carrying robot 110. For example, the local controller 728 may control the panel carrying robot 110 to drive to a location where panels are to be loaded, and subsequently, the local controller 728 may control the panel carrying robot 110 to drive to a location proximate to the panel setting robot 112. In some embodiments, the panel carrying robot 110 can use a vision module 764 (see FIG. 7) to determine a path and drive to the location proximate to the panel setting robot 112.

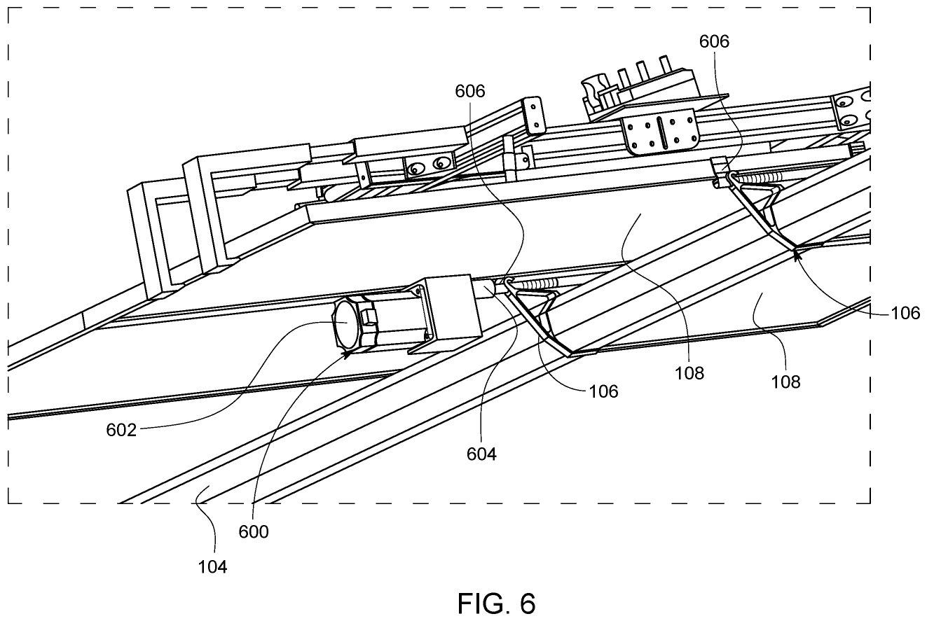

The panel setting robot 112 is designed to retrieve one or more of the solar panels 108 from the panel carrying robot 110 and place the one or more solar panels 108 on one or more brackets 106. The panel setting robot 112 may be provided in the form of a housing 124, a robotic drive assembly 126, a local controller 734 (see FIG. 7), a fastening control system 600 (see FIG. 6), a robotic arm assembly 128, a user interface 102, and the end effector 130. The housing 124 may be a hollow three-dimensional body (e.g., a rectangular prism) designed to shield elements (e.g., the local controller 734) of the panel setting robot 112 from environmental conditions. In some forms, the housing(s) includes durable latches to secure one or more components of the robotic system(s) and autonomous machines described herein. In some forms, the housing 124 is waterproof. In some forms, the one or more autonomous machines can include ventilation for proper cooling. In some embodiments, the ventilation can be provided in the form of passive air vents, or active fans.

The robotic drive assembly 126 may be provided in the form of tracks positioned and located on opposing sides of the housing 124 such that the robotic drive assembly 116 is designed to propel or drive the panel setting robot 112. It will be understood that the robot drive assembly 126 can be provided in the form of wheels or other forms of movable support for the robotic platform. The robotic drive assembly 126 may be in communication with the local controller 734 such that the panel setting robot 112 may be selectively controlled to move via the local controller 734 (see FIG. 7). For example, the local controller 734 may execute instructions to control the panel setting robot 112 to move along the length of the torque tube 104 as the panel setting robot 112 installs solar panels 108 on the torque tube 104. The panel setting robot 112 may be provided with an adjustable size solar panel lifter and a seven-axis extensible solar panel end effector to increase a reach length of the robotic arm assembly 128.

One or more of the autonomous machines can be configured to utilize a user interface 102, for operator use and troubleshooting. In the example shown in FIG. 1, the panel setting robot 112 includes the user interface, but it will be understood that one or more aspects of the installation interface 100 can include a user interface 102. In one embodiment, the user interface 102 can be provided with a sun shade or other sunblocking or glare-reducing device. In some forms, the user interface 102 can include photodiodes to provide automatic dimming in sunny conditions in order to make the screen more readable. Examples of components on the user interface 102 may include settings, alerts, alarms, notifications, lights, haptics, etc. In some embodiments, the one or more lights can be located around the perimeter of the robot(s) to provide the operator with information regardless of the position of the operator relative to the autonomous machine

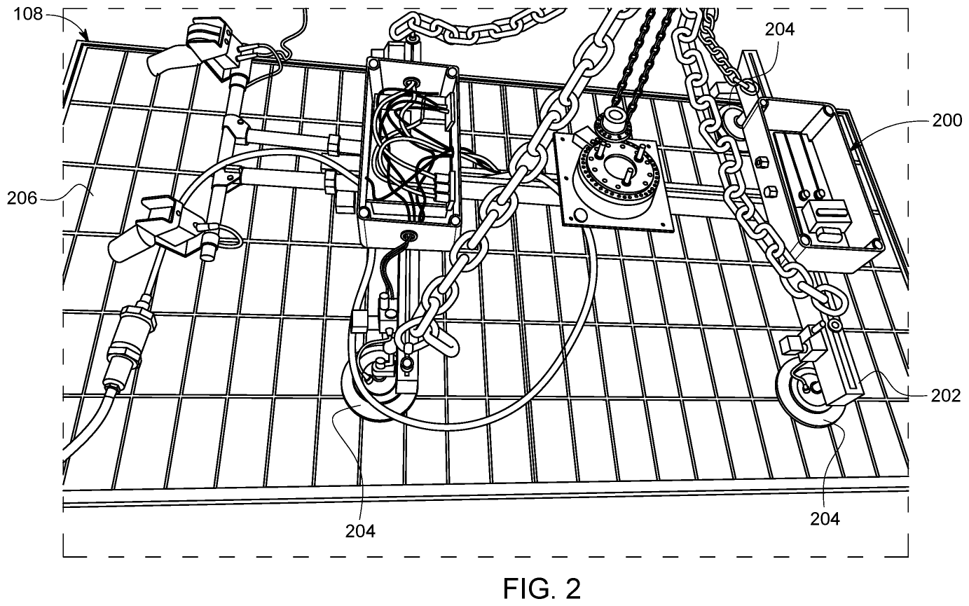

The local controller 734 may also be in communication with the robotic arm assembly 128 and the end effector 130 to control the panel setting robot 112. In some aspects, the local controller 734 may execute instructions to retrieve solar panels 108 from the panel carrying robot 110. For example, the robotic arm assembly 128 may be a robotic linkage device rotatably coupled to a base 132 of the housing 124. The robotic arm assembly 128 may be rotatably coupled to the end effector 130 and the end 134 of the robotic arm assembly 128, distal to the base 132. As will be described in greater detail in connection with FIGS. 2-4C, the end effector 130 is designed to selectively engage with the one or more solar panels 108. As a result, the local controller 734 may control the robotic arm assembly 128 to place the end effector 130 into contact with one or more solar panels 108 on the panel carrying robot 110. Once the end effector 130 is in contact with the one or more solar panels 108, the local controller 734 may instruct the end effector 130 to engage or couple with one or more of the solar panels 108. Then, the local controller 734 may maneuver the one or more solar panels 108 via the robotic arm assembly 128 to place the solar panels 108 onto the one or more brackets 106. Finally, the end effector 130 may release the one or more solar panels 108, and the panel setting robot 112 may repeat the installation process with additional solar panels 108.

FIG. 2 illustrates an end effector 200 selectively engaged with a solar panel 108. The end effector 200 is functionally similar to the end effector 130 and is provided in the form of a frame 202, one or more vacuum pods 204, and a vacuum pump (not shown). The frame 202 is designed to couple with the robotic arm assembly 128 (see FIG. 1) and to support the one or more vacuum pods 204. The frame 202 may be provided in the form of aluminum extrusion members (e.g., t-slot) arranged in an H-shape, although other suitable structures are contemplated. The one or more vacuum pods 204 may be provided in the form of suction cups adapted for selectively engaging with the one or more solar panels 108. The vacuum pump or other form of pneumatic supply is operatively coupled to the one or more vacuum pods 204 to apply a suction pressure to the one or more vacuum pods 204. For example, the one or more vacuum pods 204 may each include an orifice (not shown) in fluid communication with the vacuum pump to apply a suction pressure. In some embodiments, the vacuum pump can include, or otherwise be operatively connected to a temperature sensor. The temperature sensor can automatically purge one or more of the air lines when freezing temperatures are expected. In some forms, the system can use a trained learning model or other artificial intelligence model to predict when freezing temperatures are expected and initiate a purge of the air lines.

During the operation of the end effector 200, the robotic arm assembly 128 may maneuver the end effector 200 via the frame 202 to place the one or more vacuum pods 204 into contact with a front surface 206 of the one or more solar panels 108. Then, the vacuum pump may apply a suction pressure to the front surface 206 of the one or more solar panels 108 via the one or more vacuum pods 204. The suction pressure is applied to couple the one or more solar panels 108 to the end effector 200, such that the one or more solar panels 108 move with the end effector 200. Accordingly, the robotic arm assembly 128 may maneuver the end effector 200 to position the one or more solar panels 108 on the torque tube 104 and/or the brackets 106 (see FIG. 1). Once the one or more solar panels 108 are secured on a torque tube 104 or brackets 106, the end effector 200 may decouple from the one or more solar panels 108 by releasing the suction pressure (e.g., by de-energizing the vacuum pump or by way of a valve).

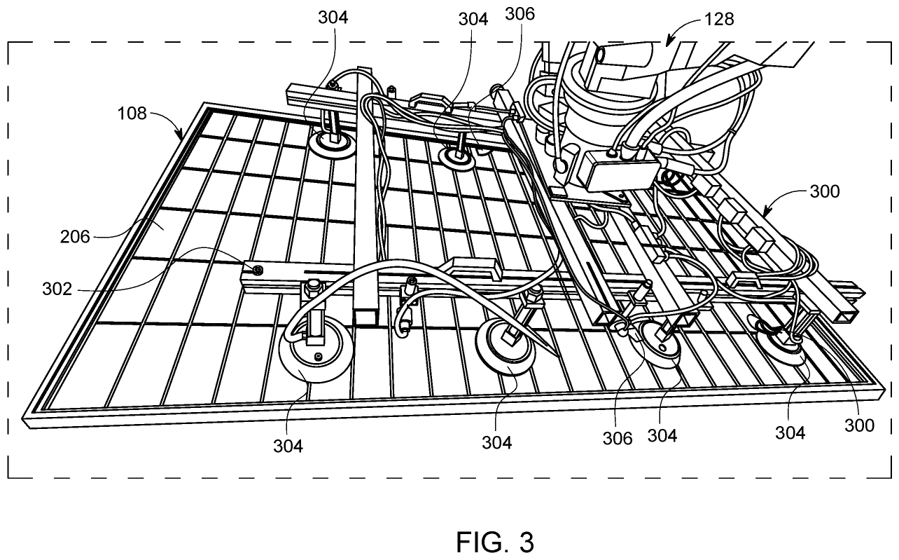

FIG. 3 illustrates another form of an end effector 300 for selectively engaging with one or more solar panels 108. The end effector 300 is provided in the form of a frame 302, one or more vacuum pods 304, a vacuum pump (not shown), and one or more nozzles 306. The frame 302 is designed to couple with the robotic arm assembly 128 and support the one or more vacuum pods 304 thereon. The frame 302 may be provided in the form of aluminum extrusion members (e.g., t-slot) arranged in a grid-shape, although other suitable structures are contemplated. The one or more vacuum pods 304 may be provided in the form of suction cups adapted for selectively engaging with the one or more solar panels 108. The vacuum pump is operatively connected or otherwise in communication with the one or more vacuum pods 304 to apply a suction pressure to the one or more vacuum pods 304 to selectively couple the end effector 300 with the one or more solar panels 108.

The one or more nozzles 306 of the end effector 300 are designed to remove debris from the front surfaces 206 of the one or more solar panels 108 and the one or more vacuum pods 404 to preferably improve the adhesion of the one or more vacuum pods 304 to the one or more solar panels 108. For example, the one or more nozzles 306 may be operatively connected or otherwise in communication with a fan or other air supply (not shown) to direct a stream of air at interfaces between the one or more solar panels 108 and the one or more vacuum pods 404. The stream of air preferably removes debris (e.g., dust) from the one or more vacuum pods 304 and/or the front surfaces 206 of the one or more solar panels 108. Accordingly, the one or more nozzles 306 may remove debris from the one or more solar panels 108 and the one or more vacuum pods 304 to improve the adhesion between the end effector 300 and the one or more solar panels 108.

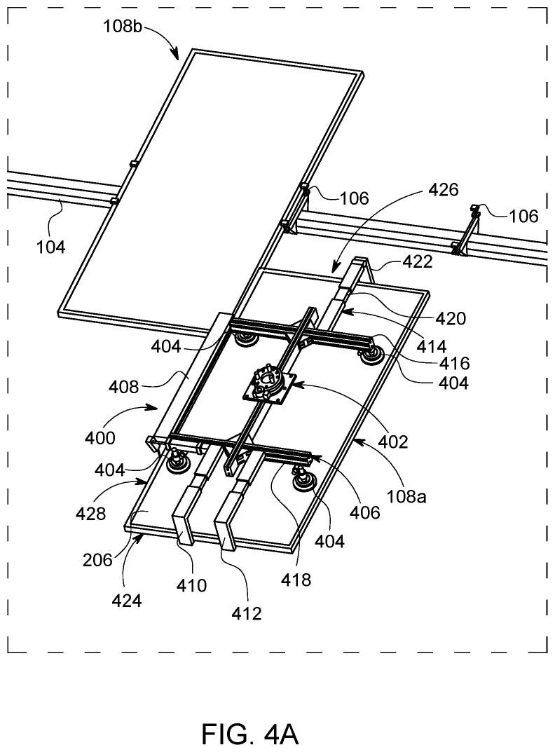

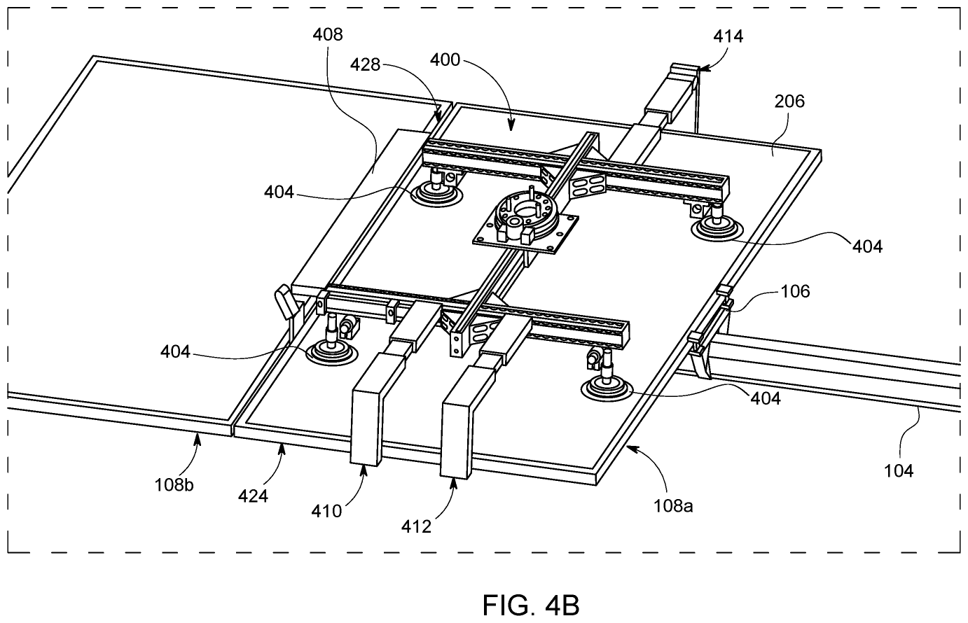

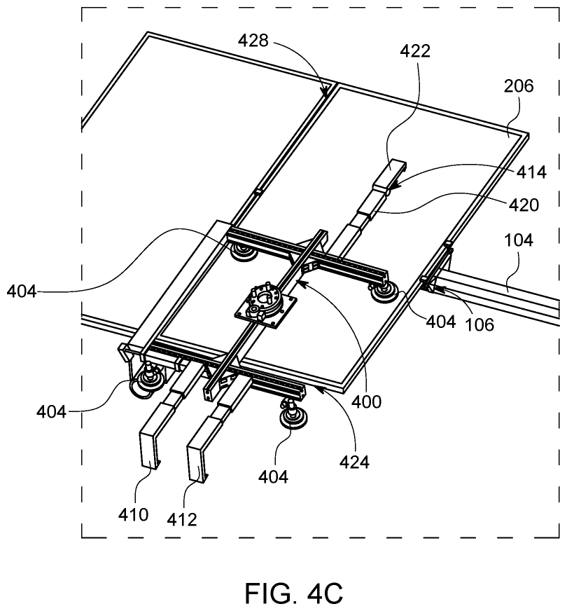

FIGS. 4A-4C illustrates another embodiment of an end effector 400 for selectively engaging with one or more solar panels 108. The end effector 400 is provided in the form of a frame 402, one or more vacuum pods 404, and a vacuum pump (not shown). Similar to the end effectors 130, 200, and 300, the frame 402 is designed to rotatebly coupled to the robotic arm assembly 128 (see FIG. 1) and support the one or more vacuum pods 404. The one or more vacuum pods 404 may be provided in the form of suction cups adapted for selectively engaging with the one or more solar panels 108. The vacuum pump is operatively coupled to the one or more vacuum pods 404 to apply a suction pressure to the one or more vacuum pods 404 to selectively couple the end effector 400 to the one or more solar panels 108.

Referring to FIG. 4A, the frame 402 is provided in the form of a chassis portion 406, a spacing member 408, a first alignment arm 410, a second alignment arm 412, and a third alignment arm 414. The chassis portion 406 is provided in the form of aluminum extrusion members (e.g., t-slot) arranged in an I-shape, although other suitable configurations are contemplated. The spacing member 408 may be provided in the form of a flat three-dimensional body (e.g., a rectangular prism) coupled to the chassis portion 406 to extend between an upper side 416 and a lower side 418 of the chassis portion 406. The first alignment arm 410 and the second alignment arm 412 extend outward from the lower side 418 of the chassis portion 406 in a generally parallel direction. The first alignment arm 410 and the second alignment arm 412 are provided in the form of J-shaped members or hook-shaped members.

The third alignment arm 414 extends outward from the upper side 416 of the chassis portion 406 in a direction generally opposite from the first alignment arm 410 and the second alignment arm 412. The third alignment arm 414 may be provided in the form of an upper member 420 and a lower member 422 pivotably coupled to one another. For example, the upper member 420 is provided in the form of a rectilinear body extending outward from the chassis portion 406 in a direction opposite from the first alignment arm 410 and the second alignment arm 412. Distal from the chassis portion 406, the upper member 420 may be pivotably coupled to the lower member 422. The lower member 422 may be provided in the form of an L-shaped body.

In the non-limiting example shown in FIG. 4A, the end effector 400 is engaged with a solar panel 108a in a first position. In the first position, the end effector 400 is designed to align the solar panel 108a with one or more brackets 106 on a torque tube 104. For example, in the first position, the vacuum pump may apply a suction pressure to the vacuum pods 404 to couple the solar panel 108a to the end effector 400. The end effector 400 may be positioned adjacent to the one or more brackets 106 located on the torque tube 104 and/or one or more adjacent solar panels 108b installed on the torque tube 104. Additionally, in the first position, the first alignment arm 410 and the second alignment arm 412 may abut a first edge 424 of the solar panel 108a, while the third alignment arm 414 may abut a second edge 426 opposite from the first edge 424. Moreover, a third edge 428 of the solar panel 108a extending between the first edge 424 and the second edge 426 may abut the spacing member 408. Accordingly, the alignment arms 410, 412, and 414 and the spacing member 408 may be in contact with at least three edges of the solar panel 108a to prevent rotation of the solar panel 108a relative to the end effector 400. Additionally, the alignment arms 410, 412, and 414 and the spacing member 408 are preferably designed to position the solar panel 108a relative to the end effector 400. For example, the alignment arms 410, 412, and 414 and the spacing member 408 may be positioned a threshold distance value from the chassis portion 406 such that the solar panel 108a is preferably centered relative to the end effector 400 when the solar panel 108a is in contact with the frame 402. In other embodiments, the end effector 400 may be alternatively configured such that the solar panel 108a is positioned asymmetrically relative to the end effector 400.

Turning to FIG. 4B, the end effector 400 is illustrated in a second position where the solar panel 108a is positioned on the one or more brackets 106 (only one bracket 106 is shown) or the torque tube 104 for installation. To transition the end effector 400 from the first position to the second position, the robotic arm assembly 128 (see FIG. 1) may move the end effector 400. More particularly, the robotic arm assembly 128 may move the end effector 400 along a plane parallel to the front surface 206 of the adjacent solar panel 108b, or the robotic arm assembly 128 may move the end effector 400 in a direction parallel to the third edge 428 of the solar panel 108a. In other embodiments, the robotic arm assembly 128 may move the end effector 400 in a direction parallel to the first edge 424 of the solar panel 108a or in a direction perpendicular to the front surface 206 of the solar panel 108a.

When the solar panel 108a is coupled to the end effector 400, the solar panel 108a will move with the end effector 400 as the end effector 400 transitions from the first position to the second position. The solar panel 108a is positioned relative to the end effector 400 using the alignment arms 410, 412, and 414 and the spacing member 408 in the second position, so the solar panel 108a may be positioned (e.g., aligned) on the one or more brackets 106 by positioning the end effector 400. Accordingly, the robotic arm assembly 128 may maneuver the end effector 400 in a precise manner to align the solar panel 108b on the torque tube 104 or the one or more brackets 106. Additionally, in the second position, the spacing member 408 preferably abuts the third edge 428 of the solar panel 108a and a portion of the adjacent solar panel 108b to position the solar panel 108a a threshold distance value from the adjacent solar panel 108b. Accordingly, the end effector 400 may position the solar panel 108a parallel to and offset from the adjacent solar panel 108b.

Turning to FIG. 4C, once the solar panel 108a has been placed onto the brackets 106 and/or torque tube 104, the end effector 400 may transition from the second position to a third position. In the third position, the end effector 400 is disengaged from the solar panel 108a such that the end effector 400 may move independently of the solar panel 108a. For example, in the third position, the vacuum pump may be de-energized such that the vacuum pods 404 are preferably at atmospheric pressure to release the solar panel 108a from the vacuum pods 404.

Additionally, in the third position, at least one of the first alignment arm 410, the second alignment arm 412, and the third alignment arm 414 may transition to allow the end effector 400 to move away from the solar panel 108a. For example, when the end effector 400 transitions from the second position to the third position, the lower member 422 of the third alignment arm 414 may rotate relative to the upper member 420. As a result, in the third position, the lower member 422 may be oriented generally parallel to the upper member 420 such that the lower member 422 is entirely positioned above the front surface 206 of the solar panel 108a. As a result, the end effector 400 may move along a plane parallel to the front surface 206 of the solar panel 108a without the third alignment arm 414 colliding with the solar panel 108a. Thus, the end effector 400 may move in a direction parallel to the third edge 428 of the solar panel 108a once the solar panel 108a has been placed on the brackets 106.

In alternative embodiments, the end effector 400 may instead move in a direction parallel to the first edge 424 of the solar panel 108a. In yet other embodiments, the end effector 400 may transition away from the solar panel 108a in a direction perpendicular to the front surface 206 of the solar panel 108a. In such embodiments, the first alignment arm 410 and the second alignment arm 412 may transition to prevent collisions with the solar panel 108a. For example, in some embodiments, the first alignment arm 410 and the second alignment arm 412 may each include members rotatably coupled to one another to release the solar panel 108a from the end effector 400. In other embodiments, the first alignment arm 410 and the second alignment arm 412 may each include members slidably coupled to one another such that the length of the first alignment arm 410 and the length of the second alignment arm 412 may be extended to release the solar panel 108a from the end effector 400.

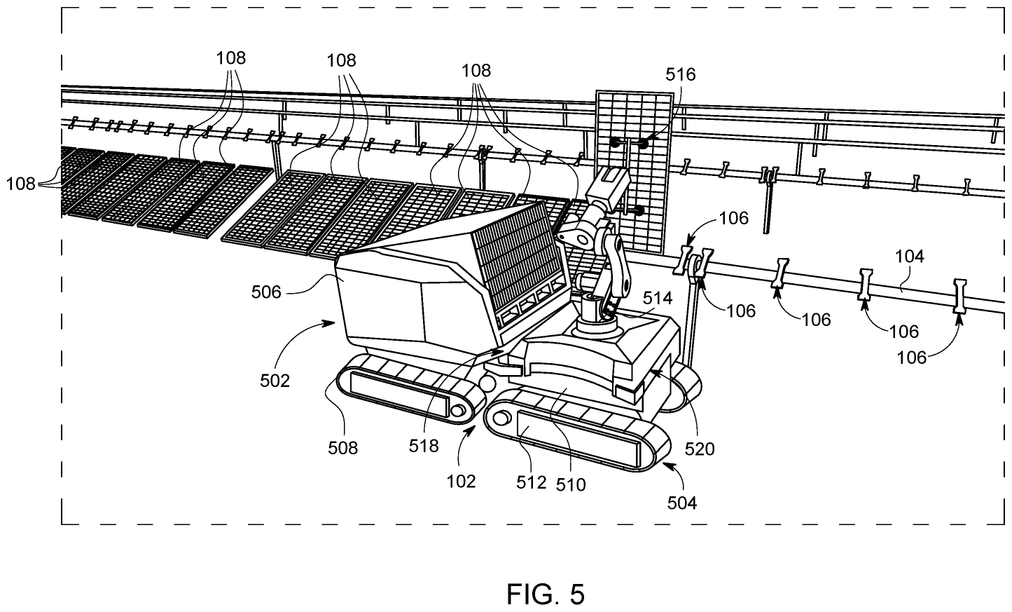

FIG. 5 illustrates another configuration for the one or more autonomous machines. Similar to the panel carrying robot 110 and the panel setting robot 112 described in connection with FIG. 1, the one or more autonomous machines are designed to work collaboratively to install solar panels 108 and may be provided in the form of one or more panel carrying robots 502 (only one illustrated) and one or more panel setting robots 504 (only one illustrated). The panel carrying robot 502 is provided in the form of a frame 506 to store solar panels 108 and a robotic drive assembly 508 to maneuver the panel carrying robot 502. The panel setting robot 504 is provided in the form of a housing 510, a robotic drive assembly 512, a robotic arm assembly 514, and an end effector 516. The robotic drive assembly 512, the robotic arm assembly 514, and the end effector 516 may be substantially similar to the robotic drive assembly 126, the robotic arm assembly 128, and the end effectors 130, 200, 300, and 400 described in connection with FIGS. 1-4C.

As further illustrated in FIG. 5, the one or more panel carrying robots 502 are designed to engage with the panel setting robot 504 on at least one of a first side 518 and a second side 520 of the housing 510. As a result, the one or more panel carrying robots 502 may move with the panel setting robot 504. For example, the panel setting robot 504 may tow or push the panel carrying robot 502 as the panel setting robot 504 moves along the length of a torque tube 104. Advantageously, the engaged configuration of the panel setting robot 504 and the panel carrying robot 502 may provide simplified controls for operating the one or more autonomous machines. For example, the panel setting robot 504 may be controlled to move along the length of the torque tube 104, while the one or more panel carrying robots 502 are simply controlled to engage with the panel setting robot 504.

Turning to FIG. 6, the panel setting robot 112, 504 (see FIGS. 1 and 5) may further include a fastening control system 600 designed to fasten one or more fasteners 606 positioned on the brackets 106. The fastening control system 600 may be provided in the form of an attachment (not shown) for the robotic arm assembly 128, 514 of the panel setting robot 112, 504. The attachment can be provided in the form of a robotic drive assembly and a local controller. The attachment can be designed to removably couple to a drive motor 602 and a drive bit component 604. The robotic drive assembly is designed to maneuver and propel the fastening control system 600 using the local controller. The drive motor 602 is coupled with the drive bit component 604 to provide rotational power to the drive bit component 604. The drive bit component 604 is designed to engage with the fasteners 606 (e.g., via a hex-socket, a hex bit, a flat-head bit, a Phillips bit, etc.) to rotate the fasteners 606. Fastening the one or more fasteners 606 on the bracket 106 secures the bracket 106 to the torque tube 104 and/or secures one or more solar panels 108 to the bracket 106. In further embodiments, the fastening control system 600 may also include more than one drive motor 602 and more than one drive bit component 604 such that the fastening control system 600 can fasten more than one fastener 606 simultaneously. Additionally, in other embodiments, the solar panel installation system 100 may include more than one fastening control system 600.

FIG. 7 illustrates a control system 700 for a solar panel installation system 100 (see FIG. 1). The control system 700 is designed to execute various commands to facilitate the installation of one or more solar panels 108. In some embodiments, the control system 700 is designed to operate fully autonomously to install the one or more solar panels 108. In other embodiments, an operator may supervise the installation and/or remotely control the installation. In some embodiments, the central controller 708 and or one or more controllers for the panel setting robot 112, 504, and/or the panel carrier robot 110, 502 can be provided in the form of a remote control, like a handheld radio controller. The control system 700 is provided in the form of a network 702, a data store 704, and an autonomous machine control system 706. The network 702, the data store 704, and the autonomous machine control system 706 may be in communication with each other either directly or indirectly via one or more wired and/or wireless connections.

The network 702 includes, for example, the Internet, intranets, extranets, wide area networks (“WANs”), local area networks (“LANs”), wired networks, wireless networks, cloud networks, or other suitable networks, or any combination of two or more such networks. For example, the network 702 can include satellite networks, cable networks, Ethernet networks, and other types of networks. In one embodiment, the network 702 is an isolated private network utilizing a private IP address and limiting access to the network 702. In some embodiments, the network 702 can include one or more computing devices or storage devices that can be arranged, for example, in one or more server banks or computer banks, or other arrangements. Such devices may host the data store 704 and/or the autonomous machine control system 706.

The data store 704 may be provided in the form of a database, a look-up table, or any other suitable data storage medium. The data store 704 may store various types of data including, for example, site-specific instructions for installing the solar panels 108, a time-stamped log of the tasks performed by the one or more autonomous machines, and other parameters associated with the one or more autonomous machines (e.g., serial numbers, firmware versions, GPS locations, battery levels, maintenance intervals, etc.). In addition, the data store 704 may store commands for the autonomous machine control system 706 to execute. The data store 704 is additionally designed to receive and update the stored data based on communications received from the autonomous machine control system 706 and other suitable devices connected to the data store 704 via the network 702. Furthermore, the data store 704 is designed to provide data to the autonomous machine control system 706 or other suitable components connected via the network 702.

The autonomous machine control system 706 is generally designed to control the operation of the one or more autonomous machines. (See FIGS. 1, 5, and 6). More particularly, the autonomous machine control system 706 may include a processor designed to execute instructions to each of the one or more autonomous machines to perform various actions associated with installing one or more solar panels 108. The autonomous machine control system 706 may be provided in the form of a central controller 708, a panel delivery control system 712, and a panel placement control system 714. The central controller may include a notification module 754, a sensor module 756, a communication module 758, an electrical safety system 760, and a disconnect switch 762. The central controller 708 may communicate with the panel delivery control system 712 and the panel placement control system 714 to control the operation of one or more panel carrying robots 110, 502 (see FIGS. 1 and 6) and one or more panel setting robots 112, 504 (see FIGS. 1 and 6), respectively. The central controller 708 of the autonomous machine control system 706 may be located proximate to the solar panel installation system 100, or the central controller 708 may be located in a data center or other off-site location. The central controller 708 may facilitate and/or coordinate replenishing the panel carrying robots 110, 502 with additional solar panels 108. Additionally, the central controller may be configured to route and/or schedule the movement of the one or more autonomous machines to prevent collisions causing damage to the system 100 and facilitate efficient installation of the solar panels 108. In some embodiments, the central controller 708 can monitor and control one or more components of the robotic system 100. In one non-limiting example, the central controller 708 can monitor a pressure of the system, or a component of the system, and send a command to a compressor to activate when a pressure level drops below a threshold value. In some embodiments, the central controller 708 can receive sensor data from the one or more sensors of the sensor arrays 732, 742 to monitor a parameter of the system (e.g., temperature, pressure, battery charge, etc.). The central controller 708 can also monitor a temperature of the system, or a component of the system and initiate the ventilation system if the temperature exceeds a threshold value.

The electrical safety system 760 can be configured to integrate one or more dynamic robotic zoning systems, which define a detailed three-dimensional work zone for the autonomous machines to travel throughout. In some embodiments, the electrical safety system 760 can be configured to detect and/or signal operators located in a work zone to prevent accidental bodily injuries. In some forms, the electrical safety system 760 can communicate with the vision module 764 for hazard detection and avoidance. The electrical safety system may be configured to recognize relevant national electrical safety standards such as NFPA 70, NFPA 79, UL 508A, OSHA, and relevant articles under regulations and standards 29 CFR 1810.

In some embodiments, electrical safety system 760, through the autonomous control system 706, utilizes a disconnect switch 762 to isolate energy from electrical cabinets and safety interlocks of the one or more autonomous machines when the machines are opened. In at least this way, the electrical safety system 760 de-energizes the electrical cabinet(s) and other electrical components to allow an operator to perform maintenance and testing on the machine(s) without exposure to hazardous voltages. The electrical safety system 760 may also be electronically configured with an e-stop switch, which may prevent damage to the hardware and software of the system 100 in the event of a collision, component malfunction, or other system issue. In one embodiment, the electrical safety system 760 can further include a lightning rod and a ground brush, to enhance the electrical safety of the system 100 and protect the components of the robotic system in the event of a short circuit, lightning event, ground fault, or similar. Additionally, all electrical components of the robotic system can include circuit protection devices. The circuit protection devices may be provided in the form of fuses, circuit breakers, or other types of overcurrent protection devices. In some embodiments, electronic overcurrent protection devices may be used to supplement the hardware-based overcurrent devices.

In addition to the electrical safety system 760, some embodiments of the system 100 may employ a vision module 764. The vision module 764 can be provided in the form of a LiDAR system, camera system, and/or a sensor suite including one or more sensing devices. The vision module 764 is designed to aid in the advanced navigation processes of the one or more autonomous machines, perform object recognition and other image processing techniques, and detect and avoid safety hazards in a field of view of one or more of the autonomous machines. Some examples of safety hazards include dust on the front surface 206 of a solar panel 108. In some embodiments, the vision module 764 can receive data from an onboard odometer of the autonomous machine. The data from the odometer (e.g., odometry data) can be used to aid the navigation system in planning a path for one or more of the autonomous machines. The vision module 764 can also be used to accurately align and place the one or more solar panels 108 on the brackets 106 and/or torque tubes 104, as described in connection with FIGS. 1-5. The vision module 764 can also be used to detect and identify one or more autonomous vehicles. For example, each panel carrying robot 110, 502 and panel setting robot 112, 504 can include a unique identifier (e.g., barcode, label, tag, serial number, QR code, etc.). The vision module 764 can identify the unique identifier for each autonomous machine and set up coordinating groups of robots so that they can communicate with one another more efficiently.

In some aspects, the panel setting robot 112, 504 identifies the location of the panel carrier robot 110, 502 using the vision module 764. In some forms, the vision module 764 uses a localization process that is accurate to approximately 1 cm and determines the position of the panel carrier robot 110, 502 (or other aspect of the system) in all dimensions. It will be understood that this example is non-limiting.

In some embodiments, the vision module 764 may be configured to detect one or more fiducial tags (not shown) placed on one or more torque tubes 104, brackets 106, or ground surface in a row. The fiducial tags can be provided in the form of a QR code, a metallic tag, a plastic tag, a barcode, a digital code, an RFID tag, an LED tag, or other type of unique identifier. In some embodiments, the fiducial tags can be provided in the form of an identifier that can be detected by the system's camera system regardless of the brightness and/or shadow in the environment. In some forms, image processing techniques can be used to detect and identify the fiducial tag. The fiducial tags can indicate a starting place for one or more of the autonomous machines to begin the panel installation process. In some embodiments, the fiducial tags may be placed by an operator and/or by another autonomous machine.

The panel delivery control system 712 may be provided in the form of a local controller 728, a robotic drive assembly control system 730, and a sensor array 732 each in communication with the other. The local controller 728 is designed to control the operation of one or more panel carrying robots 110 or 502 and may be mounted locally on one or more of the panel carrying robots 110 or 502. The local controller 728 receives inputs from the sensor array 732, the central controller 708, the data store 704, and other components connected via the network 702. The local controller 728 may execute computer-readable instructions to process inputs and generate outputs. One or more of the outputs may be communicated to the central controller 708, the data store 704, the panel placement control system 714, and/or the network 702. Additionally, one or more of the outputs may be communicated to the robotic drive assembly control system 730 to control the operation of one or more robotic drive assemblies 116, 512. The robotic drive assembly control system 730 may be provided on the local controller 728, the robotic drive assembly control system 730 (or a combination thereof), and may be provided as a processor located on one or more of the robotic drive assemblies 116, 508. The sensor array 732 may be provided in the form of one or more sensors (e.g., LIDAR sensors, cameras, ultrasonic sensors, temperature sensors, humidity sensors, moisture sensors, leak detectors, GPS modules, shaft angle encoders, etc.) positioned and located on the one or more panel carrying robots 110, 502. In one embodiment, the one or more sensors can include a moisture sensor to trigger an auto drain feature of one or more of the autonomous machines.

In operation, the panel delivery control system 712 may execute programmable instructions to generate commands for controlling the one or more panel carrying robots 110, 502 to deliver solar panels 108 to the one or more panel setting robots 112, 504. For example, in operation, the local controller 728 may process instructions to a panel carrying robot 110, 502 to travel to a location to receive solar panels 108. Such location may be provided as an input from the data store 704 or the network 702, or the local controller 728 may determine such location using inputs from the sensor array 732. Once the panel carrying robot 110, 502 has arrived at the location to receive solar panels 108, the local controller 728 may issue commands to the robotic drive assembly control system 730 such that the panel carrying robot 110, 502 remains stationary. The local controller 728 may then wait to issue further instructions until the local controller 728 determines one or more solar panels 108 have been loaded into the frame 114, 506 (see FIGS. 1 and 6). The system can determine if one or more solar panels 108 have been loaded by using a timer, the sensor array 732, communications received from the autonomous machine control system 706 or otherwise communicated over the network 702, or a combination thereof. Once the solar panels 108 have been received in the frame 114, 506, the local controller 728 can send a command to the robotic drive assembly control system 730 to drive the panel carrying robot 110, 502 to a location for the panels to be retrieved by a panel setting robot 112, 504. Such location may be proximate to a panel setting robot 112, 504 or the location may be directly adjacent to a panel setting robot 112, 504. The location may be provided as an input from the data store 704 or the network 702, or the local controller 728 may determine such location using inputs from the sensor array 732.

Once the panel carrying robot 110, 502 has arrived at the location for the solar panels 108 to be retrieved by a panel setting robot 112, 504, the panel delivery control system 712 may instruct the panel carrying robot 110, 502 to remain stationary or to follow the movements of a panel setting robot 112, 504. Simultaneously, the panel delivery control system 712 may monitor the quantity of solar panels 108 stored in the frame 114, 506 (e.g., by way of the sensor array 732 or by way of communications received from the network 702 or autonomous machine control system 706). The panel delivery control system 712 determines that the number of solar panels 108 stored in the frame 114 is below a threshold value, the panel delivery control system 712 instructs the panel carrying robot 110, 502 to travel to a location to receive additional solar panels 108, and the panel delivery control system 712 may repeat the process described herein. Advantageously, the autonomous machine control system 706 may also command more than one panel carrying robot 110, 502 simultaneously. As a result, the autonomous machine control system 706 may issue commands to one panel carrying robot 110, 502 to deliver solar panels 108 to a panel setting robot 112, 504 before another panel carrying robot 110, 502 is depleted of solar panels 108. Thus, the autonomous machine control system 706 may coordinate the delivery of solar panels 108 to a panel setting robot 112 or 514 such that the panel setting robot 112 or 514 is provided with a constant supply of solar panels 108 and there is no time spent waiting for solar panels 108.

The panel placement control system 714 may be provided in the form of a local controller 734, a robotic drive assembly control system 736, a robotic arm assembly control system 738, an end effector control system 740, a fastening control system 716, and a sensor array 742 each in communication with one another. The local controller 734 is designed to control the operation of one or more panel setting robots 112, 504 and may be mounted locally on one or more of the panel setting robots 112, 504. The local controller 734 receives inputs from the sensor array 742, the central controller 708, the data store 704, and other components connected via the network 702. The local controller 734 may execute computer-readable instructions to process the inputs and to provide outputs. One or more of the outputs may be communicated to the central controller 708, the data store 704, the panel delivery control system 712, and/or the network 702. Additionally, one or more of the outputs may be communicated to the robotic drive assembly control system 736, the robotic arm assembly control system 738, the end effector control system 740, and/or the fastening control system 716, to control the operation of the one or more robotic drive assemblies 126, 512 (see FIGS. 1 and 5), the robotic arm assemblies 128, 514 (see FIGS. 1 and 5), the end effectors 130, 200, 300, 400, and 512 (see FIGS. 1-5), and or the fastening control system 600 (see FIG. 6), respectively. The robotic drive assembly control system 736, the robotic arm assembly control system 738, the fastening control system 716, and/or the end effector control system 740 may be provided as an integrated component of the local controller 728 or may be provided as one or more processors located on the one or more robotic drive assemblies 126, 512, the robotic arm assemblies 128, 514, the fastening control system 600, and/or the end effectors 130, 200, 300, 400, and 512. The sensor array 742 may be provided in the form of one or more sensors (e.g., LIDAR sensors, cameras, ultrasonic sensors, GPS modules, shaft angle encoders, etc.) positioned and located on the one or more panel setting robots 112, 504.

In operation, the panel placement control system 714 may execute commands that result in one or more panel setting robots 112, 504 placing one or more solar panels 108 onto a torque tube 104. For example, to begin the process of placing one or more solar panels 108, the panel placement control system 714 may begin by executing commands for a panel setting robot 112, 504 to retrieve one or more solar panels 108 from a panel carrying robot 110, 502. To facilitate this, the local controller 734 may first determine the location of a panel carrying robot 110, 502 and the location and characteristics of the one or more solar panels 108 on the panel carrying robot 110, 502. These locations may be determined by way of the sensor array 742, or the locations may be received in a communication from the panel delivery control system 712, the autonomous machine control system 706, the data store 704, or the network 702. In some embodiments, the local controller 734 may communicate with the sensor array 742 to receive images from the sensor array 742, and the local controller 734 may process the images using an advanced detection system, to detect the location and characteristics (e.g., size) of the one or more solar panels 108. Once the location of the one or more solar panels 108 has been determined, the robotic drive assembly control system 736 may execute commands to position the panel setting robot 112, 504 proximate to the one or more solar panels 108. Then, the robotic arm assembly control system 738 executes commands to place the end effector 130, 200, 300, 400, and 512 of the panel setting robot 112, 504 proximate to one or more of the solar panels 108 on the panel carrying robot 110, 502. Subsequently, the end effector control system 740 controls the end effector 130, 200, 300, 400, and 512 to engage with the one or more solar panels 108.

Once the end effector 130, 200, 300, 400, and 512 is engaged with the one or more solar panels 108, the panel placement control system 714 may locate one or more brackets 106 to place the one or more solar panels 108 onto. To locate the one or more brackets 106, the panel placement control system 714 may utilize the sensor array 742, the vision module 764, or the panel placement control system 714 may receive communications from the autonomous machine control system 706, the data store 704, or the network 702. Once the one or more brackets 106 have been located, the robotic drive assembly control system 736 may execute commands to position the panel setting robot 112 or 504 proximate to the one or more brackets 106. Subsequently, the robotic arm assembly control system 738 executes commands to actuate the robotic arm assembly 128 or 514 such that the one or more solar panels 108 are placed onto the one or more brackets 106. Once the one or more solar panels 108 have been placed onto the one or more brackets 106, the panel placement control system 714 may wait until the one or more solar panels 108 have been secured to the bracket 106 (e.g., by way of the fastening control system 716) before disengaging from the one or more solar panels 108 and repeating the process with additional solar panels 108.

Once the one or more fasteners 606 on the bracket 106 have been fastened, the fastening control system 716 may communicate with the panel placement control system 714, the autonomous machine control system 706, the data store 704, and/or the network 702. The fastening control system 716 may then locate an additional bracket 106 and repeat the fastening processes with the new bracket 106. In some embodiments, the autonomous machine control system 706 and/or the fastening control system 716 may control two or more fastening control systems 600. In such embodiments, each of the two or more fastening control systems 600 may tighten or otherwise secure fasteners 606 positioned and located on the same bracket 106, or each of the two or more fastening control systems 600 may fasten fasteners 606 positioned and located on separate brackets 106.

The system 100 can further include a power module for one or more of the autonomous machines. The power module can include a generator and/or a battery management system. The battery management system can be provided in the form of lithium iron phosphate batteries, one or more sensors, one or more battery chargers, and a main battery discharge contactor. The lithium iron phosphate batteries provide improved safety features over standard rechargeable lithium battery chemistries. The battery management system is designed to monitor the batteries, control battery charging, report a battery status, and optimize battery pack longevity. The battery management system can control one or more charging processes by setting a charge rate for the battery charger(s), monitoring and/or modifying one or more battery charger parameters, and disabling a battery charger if a defect is detected. The battery management system can also control the charge and discharge of the battery pack(s) to maximize battery pack longevity and minimize damage to the battery pack(s). The battery management system can also control the main battery discharge contactor if the system detects a hazardous situation (e.g., excessive current draw, excessive temperature, overly discharged batteries, etc.). When the main battery discharge is activated, a disconnect switch is opened and the battery pack is disconnected from the system. The battery management system can also generate one or more reports related to a status of the battery pack (e.g., charge level, discharge level, fault, etc.).

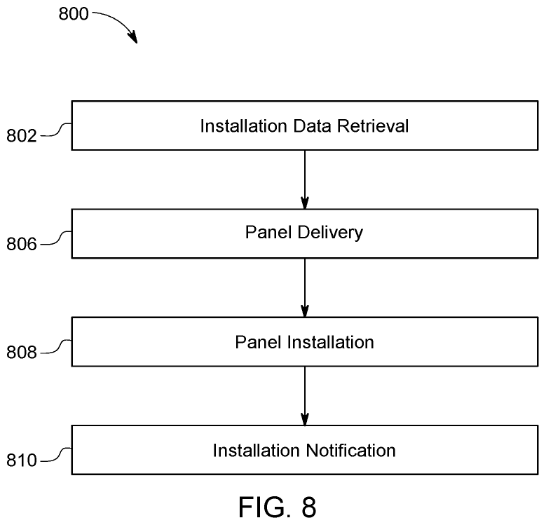

Referring to FIG. 8, a method 800 of installing one or more solar panels 108 is illustrated. The method 800 may include a step 802 of installation data retrieval, a step 806 of panel delivery, a step 808 of panel installation, and a step 810 of installation notification. Although the method 800 is illustrated as an ordered, step-by-step process, it is to be understood that the steps 802, 806, 808, and 810 may be performed in an alternative order, reverse order, or one or more of the steps 802, 806, 808, and 810 may be performed simultaneously. As described herein, the autonomous machine control system 706 (see FIG. 7) performs the steps 802, 806, 808, and 810 associated with the method 800. It is to be understood, however, that other suitable control systems may instead or also execute the method 800.

To begin executing the method 800, the autonomous machine control system 706 may begin at step 802 and execute instructions to retrieve the installation data. For example, retrieving the installation data at step 802 may include communicating with the data store 704, the notification module 754, the communication module, 758, and/or the network 702 (see FIG. 7) to retrieve data related to the solar panel installation system 100. For example, at step 802, of installation data retrieval may include steps of retrieving GPS coordinates of a torque tube 104, retrieving information related to the geometry of brackets 106, retrieving information related to the geometry of solar panels 108, and/or retrieving computer-readable instructions to be executed by the autonomous machine control system 706.

At step 806, the panel delivery process may include steps associated with retrieving one or more solar panels 108 for installation. For example, the panel delivery may include generating a command and transmitting the command to one or more panel carrying robots 110, 502 to retrieve one or more solar panels 108 for installation. As described in connection with FIG. 8, the panel delivery step may include one or more panel carrying robots 110, 502 traveling to a location to receive one or more solar panels 108. The one or more panel carrying robots 110, 502 may travel to a location proximate to one or more panel setting robots 112, 504 to deliver the one or more solar panels 108. Once the one or more panel carrying robots 110, 502 deliver the one or more solar panels 108 to the one or more panel setting robots 112, 504, the step 806 may include additional panel carrying robots 110, 502 retrieving additional solar panels 108. In some forms, the panel delivery step can include commanding two or more panel carrying robots 110, 502 to deliver solar panels 108. The two or more panel carrying robots 110, 502 may be designed to work collaboratively such that the one or more panel setting robots 112, 504 have solar panels 108 available constantly. For example, when performing panel delivery at step 806, the two or more panel carrying robots 110, 502 may perform “hot swaps” where one panel carrying robot 110 or 502 delivers one or more solar panels 108 before another panel carrying robots 110 or 502 is depleted of solar panels 108. In at least this way, the “hot swaps” allow the one or more autonomous machines to continuously install solar panels without pausing to refill with solar panels. In some forms, the panel carrying robots 110, 502 performing a hot swap can communicate with one another to verify a planned path for each robot. For example, most solar farms include rows of torque tubes that are too narrow for two sets of panel carrying robots 110, 502 to travel side by side down the row. In this example, a second panel carrying robot may travel down a row from one end, opposite the end that the first panel carrying robot traveled down. In this example, when the first panel carrying robot is depleted, it can travel back out of the row from the same end it entered.

At step 808, the panel installation may include steps associated with setting one or more solar panels 108. For example, at step 808, the panel installation may include generating and transmitting a command to the one or more panel setting robots 112, 504 to place the one or more solar panels 108 onto one or more brackets 106. As described in connection with FIG. 7, the panel installation may also include the one or more panel setting robots 112, 504 traveling to a location to retrieve the one or more solar panels 108 from the one or more panel carrying robots 110, 502. The one or more panel setting robots 112, 504 may travel to a location proximate to a torque tube 104 and/or one or more brackets 106. Next, the one or more panel setting robots 112, 504 may actuate the one or more robotic arm assemblies 116, 514 to place the one or more solar panels 108 onto the one or more brackets 106. Once the one or more solar panels 108 have been placed on the one or more brackets 106, the step 808 may include one or more fastening control systems 600 fastening one or more fasteners 606 positioned on the one or more brackets 106. As described in connection with FIG. 6, the fastening control system 600 travels to a location proximate to the one or more fasteners 606 and actuates the one or more robotic arm assemblies 738 and/or the one or more drive motors 602 to tighten the fasteners 606.

At step 810, the notification module 754 of the central controller can generate an installation notification. The installation notification may include actions associated with writing or communicating data. For example, the process for generating the installation notification may include steps of the autonomous machine control system 706 communicating with the data store 704, the notification module 754, the communication module 758, and/or the network 702. In some embodiments, installation notification may include writing data associated with the installation of one or more solar panels 108 to the data store 704. The data may include a time stamp reflecting the time that the one or more solar panels 108 were installed. Such data may also include serial numbers of the one or more solar panels 108 installed and/or the GPS location of the one or more solar panels 108 installed. Furthermore, the installation notification may include communicating with the network to send a notification to an operator and/or the central controller 708 indicating that one or more solar panels 108 have been installed.

In some forms, one or more aspects of the system 100 can notify an operator and/or the fastening control system 600 that the panel setting robot 112, 504 has stopped moving and the solar panel 108 can be released. In some embodiments, the system 100 may automatically initiate a panel release process when the solar panel is aligned. When the system is used in connection with an operator, the notification module 754 can provide an alert or notification to the operator that the panel is ready to be released and an operator can press a release button (or similar). In this example, the system 100 can automatically send information to the data store 704 indicating that the solar panel has been installed when the release button is pressed.

The system can also be adapted to generate, train, and execute a plurality of trained learning models, nodes, neural networks, gradient boosting algorithms, mutual information classifiers, random forest classifications, and other machine learning and artificial intelligence-related algorithms to process the parameters, features, and other data elements. In some embodiments, the one or more trained learning models can include deep learning, machine learning, neural networks, vision, and similar advanced artificial intelligence-based technologies. When used throughout the present disclosure, one skilled in the art will understand that processes for iteratively training the “trained learning model” can include machine learning processes and other advanced artificial intelligence processes. For example, the system and processes of the present disclosure can perform data processing, image analysis, generate tasks or action items, provide customized recommendations according to user settings and preferences, generate interfaces, generate reports, generate files, generate notifications, and similar processes. In some embodiments, the system may use additional inputs and/or feedback loops to an iterative training process for a personalized event hosting process based on a plurality of parameters and adjustable metric values.

The previous description of the disclosed embodiments is provided to enable any person skilled in the art to make, use, or practice the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

Specific embodiments of a system and method for solar panel installation according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. An advanced robotic system for installing solar panels, comprising:
a solar panel setting robot provided in a form of a first robotic system including a robotic arm assembly designed to articulate a solar panel and install the solar panel on a bracket coupled to a torque tube;
an end effector rotatably coupled to an end of the robotic arm assembly;
vacuum pods attached to a frame of the end effector, wherein the vacuum pods are designed to suction to the solar panel;
a solar panel carrying robot provided in the form of a second robotic system designed to carry multiple solar panels and travel in proximity to the solar panel setting robot; and
a control system configured to coordinate installation activities between the solar panel setting robot and the solar panel carrying robot.

2. The system of claim 1, wherein the control system further comprises:
a panel delivery control system;
a panel placement control system; and
a central controller.

3. The system of claim 2, wherein the central controller further comprises:
a vision module;
a notification module;
a sensor module;
a communication module; and
an electrical safety system.

4. The system of claim 1, wherein the solar panel setting robot is configured to identify an installation location for the solar panel and deploy a notification through a notification module of the control module.

5. The system of claim 2, wherein the control system further comprises a disconnect switch.

6. The system of claim 1, wherein the solar panel setting robot uses a vision module to align the solar panel with the bracket.

7. The system of claim 2, further comprising multiple solar panel carrier robots designed to communicate to each other to facilitate continuous solar panel installation.

8. The system of claim 3, wherein a communication module sends a release signal to the system to indicate that the panel setting robot is no longer moving or is otherwise aligned in an installation position.

9. The system of claim 2, wherein the panel placement control system further comprises a fastening control system for tightening one or more fasteners to secure the solar panel to the bracket.

10. The system of claim 2, wherein the electrical safety system is configured to integrate dynamic robotic zoning systems defining a three-dimensional work zone for the first robotic system and the second robotic system.

11. A system for installing solar panels, comprising:
a solar panel setting robot provided in the form of a first robotic system, wherein the solar panel setting robot comprises:
a waterproof housing;
a robotic drive assembly designed to transport the solar panel setting robot from one location to another;
a local controller;
a robotic arm assembly designed to articulate a robotic arm of the solar panel setting robot; and
an end effector designed to removably couple to a solar panel;
a plurality of solar panel carrying robots provided in a form of a second robotic system including one or more modules; and
a control system designed to coordinate installation activities between the solar panel setting robot and the plurality of solar panel carrying robots.

12. The system of claim 11, wherein the control system further comprises:
a panel delivery control system comprising an advanced navigation system for planning a route from a solar panel pickup location to a solar panel installation location;
a panel placement control system comprising a vision module for aligning the solar panel with a bracket; and
a central controller designed to control one or more aspects of the first robotic system, the second robotic system, or a combination thereof.

13. The system of claim 12, wherein the central controller further comprises:
a notification module;
a sensor module provided in the form of a sensor array;
a communication module; and
an electrical safety system.

14. The system of claim 11, wherein the end effector comprises:
a frame configured to couple with the robotic arm assembly; and
a vacuum pump and a plurality of vacuum pods, each configured to selectively engage with the solar panel.

15. The system of claim 14, wherein the end effector further comprises:
a plurality of nozzles configured to remove debris from a front surface of the solar panel.

16. The system of claim 14, wherein the frame further comprises:
a chassis portion;
a spacing member;
a first alignment arm;
a second alignment arm; and
a third alignment arm.

17. The system of claim 14, wherein the vacuum pump is configured to de-energize to release the solar panel from the vacuum pods after the solar panel is installed.

18. A method of installing solar panels using an advanced robotic platform, the method comprising:
providing one or more autonomous machines provided in a form of a solar panel setting robot and a solar panel carrying robot;
identifying an installation location for a first solar panel installation using a navigation module of the solar panel setting robot;
driving the one or more autonomous machines to the installation location using a drive module of the solar panel setting robot;
initiating an installation process including:
sending a notification to a central controller using a communication module that the installation process has been initiated;
retrieving a solar panel from the solar panel carrying robot using a robotic arm assembly of the panel setting robot;
aligning the solar panel with a bracket according to one or more parameters using a vision module; and
fastening the solar panel to the bracket using one or more fasteners.

19. The method of claim 18, wherein aligning the solar panel further comprises:
applying a suction pressure to a plurality of vacuum pods to couple the solar panel to an end effector coupled to an end of the robotic arm assembly of the solar panel setting robot;
moving the end effector from a first position to a second position where the solar panel is positioned on the plurality of brackets on a torque tube at the second position; and
de-energizing a vacuum pump and disengaging the end effector from the solar panel by releasing the vacuum pods, such that the end effector may move independently of the solar panel.

20. The method of claim 18, further comprising:
identifying the solar panel as being installed using the vision module, including a unique identifier for the solar panel;
identifying the unique identifier for the solar panel; and
transmitting an installation notification to a data store including the unique identifier associated with the solar panel and an installed status.
